(19) United States
(12) Patent Application Publication
(10) Pub. No.: US 2025/0017238 A1
(43) Pub. Date: Jan. 16, 2025

(54) METHOD FOR PRODUCING PLANT WATER

(71) Applicants: Camille SCHMIT, Chernex (CH); Fabrice THUELER, Courroux (CH)

(72) Inventors: Camille SCHMIT, Chernex (CH); Fabrice THUELER, Courroux (CH)

(21) Appl. No.: 18/713,460

(22) PCT Filed: Nov. 25, 2021
(86) PCT No.: PCT/IB2021/060960

§ 371 Date: May 24, 2024

(51) Int. Cl. A23L 2/04; A23L 2/38; A23L 2/58

(52) U.S. Cl. CPC A23L 2/04; A23L 2/38; A23L 2/58

(57) ABSTRACT

The invention relates to a method for producing plant water from vegetation harvested less than 8 h prior, such as a fruit and/or a vegetable and/or a plant, comprising the steps consisting in:—placing vegetation into a chamber that is under a greater or lesser level of vacuum;—heating the vegetation to a temperature of between 2° C. and 95° C. and for a duration of between 2 h and 150 h;—recovering the water contained in said vegetation, said plant water containing a total concentration of substances of plant origin dissolved in the water in an amount of up to 20 mg/l, the water having a pH of 4 to 7, a neutral or nearly-neutral RH2 and a low conductivity of less than 50 uS/cm.

The present invention relates to a method for producing plant water from plant materials, in particular water extracted by drying, without chemical solvents, and the use thereof in particular in food compositions, beverages and health care.

The dehydration of vegetation, without plant water recovery and reclamation, is a method that many civilizations have been using for years, as described at the following Internet links: https://www.deshydrateur.biz, and http://www.ronalpenford.com/pouvez-vous-deshydrater-les-aliments-utilisation-du-soleil/. In fact, it is one of the oldest methods of food preservation.

Today's consumers are increasingly health-conscious and sensitive to the origin and nature of the food they eat.

Water is essential to life. It not only provides the body with vitality, but also hydrates it so that it can carry out its daily functions.

To date, the water marketed by local authorities and food companies is terrestrial water, whereas the plant water used in this invention comes from the plant kingdom.

To date, water from the plant kingdom has been obtained either by mechanical pressure, which produces juices in the form of plant concentrates to which terrestrial water is added, or by distillation or other methods.

For the body's well-being, it is ideal to drink pure, living water that is in tune with human physiology. This is not so straightforward today, since both city water and PET bottled water are flawed in these respects, containing numerous residues of drugs and agricultural pesticides.

Water performs a transport function in our bodies, not a supply function. Water's role is rather to assist metabolism by transporting nutrients to the cells and freeing the body from toxic metabolic waste, such as uric acid.

CH715829 in the applicant's name discloses a lime-free plant-based water that is low in salts and organic and mineral substances and ideally supports metabolic functions.

The aim of the present invention is to provide a water with improved nutritional qualities, improved palatability and improved visual appeal, making it easy for anyone, especially children, to consume such a water.

In accordance with the invention, a method for producing plant water from vegetation harvested less than 8 h prior, such as a fruit and/or a vegetable and/or a plant, comprising the steps of:
placing vegetation into a chamber that is under a greater or lesser level of vacuum;
heating the vegetation to a temperature of between 2° C. and 95° C. and for a duration of between 2 h and 150 h;
recovering the water contained in said vegetation, said plant water containing a total concentration of substances of plant origin dissolved in the water in an amount of up to 20 mg/l, the water having a pH of 4 to 7, a neutral or nearly-neutral RH2 and a low conductivity of less than 50 uS/cm.

Preferably, owing to the method of the present invention, vegetation from which water has been extracted have retained all or part of their structural frame.

In one embodiment, the method makes it possible to obtain water containing a total concentration of substances of plant origin dissolved in the water in an amount of less than 20 mg/l.

In order to influence the coloring of the beverage in a totally natural way, but also the taste, the method of the present invention makes it possible to obtain a water naturally colored by the presence of vegetation arranged in the form of a spice, in particular turmeric or vanilla.

The method makes it possible to obtain plant water from fruits, vegetables, plants and/or spices.

The method of the present invention makes it possible, when the vegetation is drained of its water, to preserve said vegetation for use as food, compost or fertilizer.

The plant water of the present invention can be consumed as a beverage, medicinal food, dietary supplement or cosmetic. The plant water of the present invention can therefore be used to nourish and hydrate consumers.

With the present method, only the H2O molecules from the vegetation are recovered, while the organic matter, together with the enzymes, vitamins and mineral salts, remains in the vegetation.

In accordance with the invention, a method for producing plant water from vegetation harvested less than 8 h prior, such as a fruit and/or a vegetable and/or a plant, comprises the steps of:
placing vegetation into a chamber that is under a greater or lesser level of vacuum;
heating the vegetation to a temperature of between 2° C. and 85° C. and for a duration of between 2 h and 150 h;
recovering the water contained in said vegetation, said plant water containing a total concentration of substances of plant origin dissolved in the water in an amount of up to 20 mg/l, the water having a pH of 4 to 7, a neutral or nearly-neutral RH2 and a low conductivity of less than 50 uS/cm.

To produce a product that retains all the virtues of the vegetation, the method must be implemented as close as possible to the crops, so as to extract the water within eight hours or even two hours of harvesting.

Preferably, the plant water obtained by the method is extracted by drying fruits, vegetables or plants.

Preferably, the plant water obtained by the method contains dry matter dissolved in water in a small amount of less than 20 mg/l or even 10 mg/l.

In another embodiment, the plant water composition obtained by the method further comprises additional additives.

In one embodiment, the plant water obtained by the method is used in the cosmetics field, for example as a make-up remover lotion.

In another embodiment, the plant water obtained by the method is used in the medical field, notably to treat cancers, rheumatism, gout, chronic infections and cellulite.

In another embodiment, the plant water obtained by the method is placed in a packaging such as a bottle or brick, as a beverage or dietary supplement.

In another embodiment, the plant water obtained by the method can be composed of an assortment of fruits and/or vegetables and/or plants, dried at the same time or not in a dedicated machine.

To obtain this plant water, the method makes it possible to keep aside all the nutrients contained in each of cells of this vegetation.

According to the present method, low-temperature drying enables almost total extraction of the water contained in the vegetation. Indeed, gentle dehydration should be done by cold-drying the vegetation at low temperature and low pressure to enable a gaseous supply of hot air, which evaporates the water contained in the vegetation. Drawn directly from the heart of the vegetation, the plant water extracted is pure. It contains no calories, but may contain minute traces of organic substances (lipids, carbohydrates and proteins).

Another advantage of the present invention is that, on the one hand, the method recovers pure plant water containing virtually only H2O molecules and, on the other hand, the dry plant material is ready for consumption or for use in various preparations.

In one embodiment, the plant water obtained by the method is used as a food product or as an alcoholic or non-alcoholic beverage.

According to this embodiment, the plant water obtained by the method is used, for example, in the preparation of beer.

Still according to this embodiment, the plant water obtained by the method is used in the preparation of a sorbet or ice cream, for example.

No solvents are used to make the plant water. What is more, as part of an ecological approach, in addition to using very little energy to extract the water, surplus or damaged vegetation, such as organic fruit and vegetables, can be used to extract the water therefrom.

The features of the invention will become clearer upon reading this embodiment given only by way of example, which is in no way limiting.

In this example, a laboratory analysis showed that organic apple and edelweiss water obtained via the method has a pH of 5.1, a conductivity of 4, a total concentration of substances dissolved in the plant-based water of 2.56 PPM, and a dry matter concentration of less than 0.10 mg/l. In this example, the RH2 is 28.

From an organoleptic point of view, the plant water obtained by the method and characterized in the table is clear, with a very light odor and a pleasant, mild, subtle taste. Through careful selection, this plant water is free from uranium, arsenic, heavy metals and pesticide metabolites.

The plant water obtained by this method has a pH of 5.1 in this example. The pH level reflects the acidity of the water. The pH (hydrogen potential) refers to the amount of hydrogen in water. Drinking water that is too basic ultimately upsets the stomach's ability to digest, which takes place in a highly acidic environment. As a result, further digestion is difficult. It is therefore advisable to drink fairly acidic water, like the water in the sample.

In one example, the plant water obtained via the method can be obtained from a mixture of apples and edelweiss. This water can be used as a base for cosmetic creams.

In another, non-detailed example, the plant water obtained via the method is obtained from grapes after harvesting to produce a plant water that complements wine. The remainder of the H2O molecules in the grapes used to make the wine are extracted by drying to obtain a plant water that is “complementary” to the wine-making process.

In order to preserve all the virtues of vegetation, mobile plant water production units get as close to the vegetation as possible.

1. A method for producing plant water from vegetation harvested less than 8 h prior, such as a fruit and/or a vegetable and/or a plant, comprising the steps of:
placing vegetation into a chamber that is under a greater or lesser level of vacuum;
heating the vegetation to a temperature of between 2° C. and 95° C. and for a duration of between 2 h and 150 h;
recovering the water contained in said vegetation, said plant water containing a total concentration of substances of plant origin dissolved in the water in an amount of up to 20 mg/l, the water having a pH of 4 to 7, a neutral or nearly-neutral RH2 and a low conductivity of less than 50 uS/cm.

2. The method according to claim 1, wherein the vegetation from which water has been extracted have retained all or part of their structural frame.

3. The method according to one of claim 1 or 2, wherein the water contains a total concentration of substances of plant origin dissolved in the water in an amount of less than 20 mg/l.

4. The method according to one of the preceding claims, wherein the water is naturally colored by the presence of vegetation arranged in the form of a spice, in particular turmeric.

5. The method according to one of claims 1 to 4, wherein the vegetation is extracted from fruit.

6. The method according to one of claims 1 to 4, wherein the vegetation is extracted from vegetables.

7. The method according to one of claims 1 to 4, wherein the vegetation is extracted from plants.

8. The method according to one of claims 1 to 4, wherein the vegetation is extracted from spices.

9. The method according to one of the preceding claims, wherein the vegetation is extracted from edelweiss and preferably at least one other type of vegetation.

10. The method according to one of the preceding claims, wherein the conductivity of the water is less than 50 uS/cm, typically less than 10 uS/cm.

11. The method according to one of the preceding claims, wherein the vegetation, once its water is extracted, is arranged to serve as food, compost or fertilizer.
